(19) United States
(12) Patent Application Publication
(10) Pub. No.: US 2020/0213510 A1
(43) Pub. Date: Jul. 2, 2020

(54) SYSTEM AND METHOD TO CAPTURE AND CUSTOMIZE RELEVANT IMAGE AND FURTHER ALLOWS USER TO SHARE THE RELEVANT IMAGE OVER A NETWORK

(71) Applicants: Luke Trevitt, CAMPERDOWN (AU); Lee Hunter, CAMPERDOWN (AU); Evan Stuart, CAMPERDOWN (AU)

(72) Inventors: Luke Trevitt, CAMPERDOWN (AU); Lee Hunter, CAMPERDOWN (AU); Evan Stuart, CAMPERDOWN (AU)

(21) Appl. No.: 16/236,504

(22) Filed: Dec. 30, 2018

(51) Int. Cl. H04N 5/232; H04L 29/06; G06K 9/00

(52) U.S. Cl. CPC H04N 5/23222; H04L 63/0272; H04N 2005/4405; H04N 5/23219; G06K 9/00268; H04N 5/232411

(57) ABSTRACT

A system and method for capturing and customizing relevant image and allowing a user to share the relevant image over the network. The method captures an image containing features of a subject. The method then establishes a wireless connection with an external hardware unit. The method transmits the captured image to the external hardware unit. Further, the method comprises a step of identifying the features in the received image. The method determines states of a light sensor and an IR sensor. Furthermore, the method comprises aligns a camera module of the external hardware unit with the identified features of the received image to capture a relevant image. The light sensor and IR sensor are integrated with the camera module. The method then stores the relevant image in a storage module configured with the external hardware unit. Then the method customizes the relevant image based on the identified features.

### TECHNICAL FIELD

The present invention relates to a system and method to capture and customize a relevant image of subject and further allows a user to share the relevant image over a network, in particular to system and method to capture a plurality of relevant images per day and customize the captured image into a video sequence which depicts the passing of time and/or growth of the subject such as a baby.

### BACKGROUND

Background description includes information that may be useful in understanding the present invention. It is not an admission that any of the information provided herein is prior art or relevant to the presently claimed invention, or that any publication specifically or implicitly referenced is prior art.

Typically, the image capturing systems and methods are employed to take photos. Rapid improvements in the digital world have changed the image capturing systems as digital cameras, video camera mobile phones, notebook computers, tablet, etc. In addition to the function of capturing images, the digital cameras also have the photographic function of recording dynamic movies. The photos or movies acquired by the digital cameras may be stored in a storage device (e.g., a hard disk) in the form of electronic files. The user may watch the images of the photos and the movies through an electronic device, and the favorite images may be selected and outputted as the conventional photos.

Moreover, since the image pickup devices are digitalized, it is important to manage the electronic files of the captured images and the videos. Generally, the images or the videos captured by these image capturing systems are transmitted to a computer host. Under the execution of an operating system in the computer host, a photo folder may be created to store the images and videos.

US patent application number 20170214849 A1 issued to Jung-Jen Lee discloses a method for automatically recording baby photos and a baby photo recording system. It generates multiple image frames by shooting a baby. The multiple image frames are formed as a video stream or at least one video file. The method then analyses the image frames to capture at least one of the image frames meeting a shooting condition as at least one target photo. It stores the at least one target photo and selects under a screening condition one of the target photos in each pre-set period as a representative photo respectively and places the representative photos into a record template to form a photo record.

Chinese patent application number 107277274 A issued to Wang discloses a method for recording the growth process of an image. The method comprises the steps that an image is photographed, and the photographed image file is stored in a specific target database. The image file carries photographing time information. The growth process recording timeline presentation data is automatically generated by extracting the photographing time information and the image information from the image file of the specific target database based on the generated growth process recording timeline presentation data. The timeline and the image information arranged on the timeline according to time are displayed on display. The automatic recording and saving of the photographed image and automatic matching of the current photographing time are carried out to generate the growth process recording timeline presentation data, and the data are correspondingly displayed on the timeline.

There is a need for an efficient and effective system and method for capturing and customizing relevant image and further allowing a user to share the relevant image over a network. Further, there is also a need for a system and method for editing the captured relevant images into a video sequence and further allowing a user to edit and modify the video sequence and share the modified video sequence.

Thus, in view of the above, there is a long-felt need in the industry to address the aforementioned deficiencies and inadequacies.

Further limitations and disadvantages of conventional and traditional approaches will become apparent to one of skill in the art through comparison of described systems with some aspects of the present disclosure, as set forth in the remainder of the present application and with reference to the drawings.

The present invention mainly solves the technical problems existing in the prior art. In response to these problems, the present invention provides a system and method for capturing and customizing relevant image and further allowing a user to share the relevant image over a network.

An aspect of the present disclosure relates to a system to capture and customize a relevant image of a subject and further allows a user to share the relevant image over a network. The system includes a processor and a memory. The memory stores machine-readable instructions that when executed by the processor cause the processor to capture an image containing a plurality of features of a subject through a capture module. The capture module is integrated with an algorithmic module. The processor is further configured to establish a wireless connection with an external hardware unit through a pairing module integrated with the algorithmic module. The processor is then configured to transmit the captured image to the external hardware unit through a sharing module integrated with the algorithmic module.

Furthermore, the processor is configured to identify the features in the received image through an identification module configured with the external hardware unit. The processor is then configured to determine a plurality of states of a light sensor, and an IR sensor through a status module configured with the external hardware unit.

Furthermore, the processor is then configured to align a camera module of the external hardware unit with the identified features of the received image to capture a relevant image through an alignment module configured with the external hardware unit. The user sets the relevant image during the initialization of the software application (capture a photo of the subject). The relevant image is updated throughout the lifetime of the subject.

The light sensor and the IR sensor are integrated with the camera module. The processor is then configured to store the relevant image in a storage module configured with the external hardware unit. The processor is then configured to customize the relevant image based on the identified features through a customization module configured with the external hardware unit.

In an aspect, the plurality of states comprises at least one of an ON state and an OFF state.

In an aspect, the alignment module further detects a plurality of facial expressions of the subject through a scanning camera configured with the external hardware unit.

In an aspect, the light sensor detects a plurality of light conditions.

In an aspect, the IR sensor detects at least one feature of the subject to determine a presence of the subject such as a baby in the received image.

An aspect of the present disclosure relates to a computer-implemented method for capturing and customizing relevant image and further allowing a user to share the relevant image over a network. The method comprises a step of capturing an image containing a plurality of features of a subject through a capture module. The capture module is integrated with an algorithmic module via a cloud network. The cloud network establishes wireless communication between the algorithmic module and the capture module. The method comprises a step of establishing a wireless connection with an external hardware unit through a pairing module integrated with the algorithmic module. The method then comprises a step of transmitting the captured image to the external hardware unit through a sharing module integrated with the algorithmic module. Further, the method comprises a step of identifying the features in the received image through an identification module configured with the external hardware unit. The method further comprises a step of determining a plurality of states of a light sensor, and an IR sensor through a status module configured with the external hardware unit.

Furthermore, the method comprises a step of aligning a camera module of the external hardware unit with the identified features of the received image to capture a relevant image through an alignment module configured with the external hardware unit, wherein the light sensor, and the IR sensor are integrated with the camera module. The method then comprises a step of storing the relevant image in a storage module configured with the external hardware unit. Then the method comprises a step of customizing the relevant image based on the identified features through a customization module configured with the external hardware unit.

An aspect of the present disclosure relates to a device in a network. The device comprises a non-transitory storage device and one or more processors. The non-transitory storage device having embodied therein one or more routines operable to capture and customize a relevant image of a subject and further allows a user to share the relevant image over a network. The one or more processors are coupled to the non-transitory storage device and operable to execute the one or more routines. The one or more routines include a capture module, a pairing module, a sharing module, an identification module, a status module, an alignment module, a storage module, and a customization module.

The capture module is configured to capture an image containing a plurality of features of a subject. The capture module is integrated with an algorithmic module. The pairing module integrated with the algorithmic module to establish a wireless connection with an external hardware unit. The sharing module is integrated with the algorithmic module to transmit the captured image to the external hardware unit. The identification module configured with the external hardware unit to identify the features in the received image. The status module configured with the external hardware unit to determine a plurality of states of a light sensor and an IR sensor. The alignment module is configured with the external hardware unit to align a camera module of the external hardware unit with the identified features of the received image to capture a relevant image. The light sensor and the IR sensor are integrated with the camera module. The storage module is configured with the external hardware unit to store the relevant image. The customization module is configured with the external hardware unit to customize the relevant image based on the identified features.

Accordingly, one advantage of the present invention is that it captures the relevant image (a quality image per day) and enables the user to edit the captured relevant images into a video sequence which depicts the passing of time or transformation of the captured relevant image such as the growth of a baby.

Accordingly, one advantage of the present invention is that it allows the user to edit and modify the video sequence and share the modified video sequence over the network as desired.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a network implementation of the present system and method to capture and customize a relevant image of a subject and further allows a user to share the relevant image over a network, in accordance with at least one embodiment;

FIG. 2 illustrates a block diagram of the present system for capturing and customizing a relevant image of a subject and further allowing a user to share the relevant image over a network, in accordance with at least one embodiment;

FIG. 3 illustrates a flowchart of the method for capturing and customizing a relevant image of a subject and further allowing a user to share the relevant image over a network, in accordance with at least one embodiment;

FIG. 4 illustrates a first operational flowchart of the present invention, in accordance with at least one embodiment; and

FIG. 5 illustrates a second operational flowchart of the present invention, in accordance with at least one embodiment.

### DETAILED DESCRIPTION

Systems and methods are disclosed for capturing and customizing relevant image and further allowing a user to share the relevant image over a network. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of capturing and customizing relevant image and further allowing a user to share the relevant image over a network, it should be appreciated that the same has been done merely to illustrate the invention in an exemplary manner and any other purpose or function for which explained structures or configurations can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or digital versatile disk (DVD), flash memory, memory or memory devices.

A computer program product may include code and machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer program product) may be stored in a machine-readable medium. A processor(s) may perform the necessary tasks.

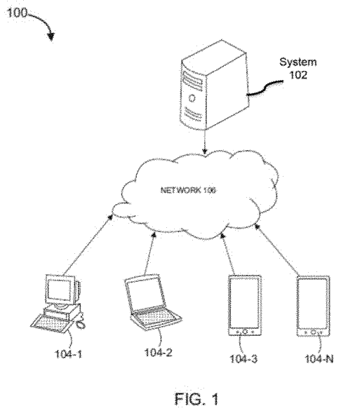

FIG. 1 illustrates a network implementation 100 of the present system and method to capture and customize a relevant image of a subject and further allows a user to share the relevant image over a network, in accordance with at least one embodiment. Although the present invention is explained by considering that the present system 102 is implemented on a server, it may be understood that the present system 102 may also be implemented in a variety of computing systems, such as a laptop computer, a desktop computer, a notebook, a workstation, a mainframe computer, a server, a network server, and the like. It will be understood that the present system 102 may be accessed by multiple users through one or more computing devices 104, collectively referred to as computing device 104 hereinafter, or applications residing on the computer devices 104. Examples of the computing devices 104 may include but are not limited to, a portable computer, a personal digital assistant, a handheld device, and a workstation. The computing devices 104 are communicatively coupled to the present system 102 through a network 106 and utilizes the various operating system to perform the functions of the present system 102 such Android, IOS, Windows, etc.

In one implementation, the network 106 may be a wireless network, a wired network or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

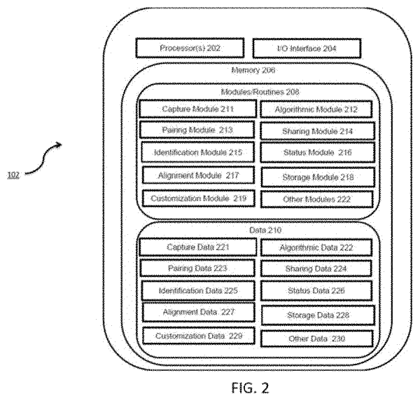

FIG. 2 illustrates a block diagram of the present system 102 for capturing and customizing a relevant image of a subject and further allowing a user to share the relevant image over a network, in accordance with at least one embodiment. In one embodiment, the system 102 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the computing devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a capture module 211, an algorithmic module 212, a pairing module 213, a sharing module 214, an identification module 215, a status module 216, an alignment module 217, a storage module 218, a customization module 219, and other modules 222. The other modules 222 may include programs or coded instructions that supplement applications and functions of the system 102.

The data 210, amongst other things, serves as a repository for storing data processed, received, and generated by one or more of the modules 208. The data 210 may also include capture data 221, algorithmic data 222, pairing data 223, sharing data 224, identification data 225, status data 226, alignment data 227, storage data 228, customization data 229, and other data 230. The other data 230 may include data generated as a result of the execution of one or more modules in the other modules 222.

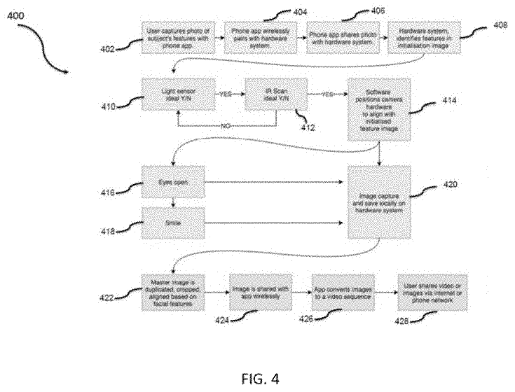

In one implementation, the capture module 211 is configured to capture an image containing a plurality of features of a subject. The capture module 211 is integrated with the algorithmic module 212. In an embodiment, the algorithmic module 212 is a software application can be implemented on various operating systems like Android, IOS, and Windows, etc. The pairing module 213 is integrated with the algorithmic module 212 to establish a wireless connection with an external hardware unit 408 (shown in FIG. 4). The sharing module 214 is integrated with the algorithmic module 212 to transmit the captured image to the external hardware unit 408. The identification module 215 is configured with the external hardware unit 408 to identify the features in the received image.

The status module 216 is configured with the external hardware unit 408 to determine a plurality of states of a light sensor and an IR sensor. In an embodiment, the plurality of states comprises at least one of an ON state and an OFF state. The alignment module 217 is configured with the external hardware unit 408 to align a camera module of the external hardware unit 408 with the identified features of the received image to capture a relevant image.

The user sets the relevant image during the initialization of the software application (capture a photo of the subject). The relevant image is updated throughout the lifetime of the subject. In an embodiment, the alignment module further detects a plurality of facial expressions of the subject through a scanning camera configured with the external hardware unit. In an additional embodiment, the alignment module 217 further identifies the face alignment of the subject and lighting conditions of the environment. In a further additional embodiment, the alignment module 217 further identifies the sound, movement, predefined conditions by visual (photo) reference.

The light sensor and the IR sensor are integrated with the camera module. In an aspect, the light sensor detects a plurality of light conditions. In an embodiment, the IR sensor detects at least one feature of the subject to determine a presence of the subject such as a baby in the received image. Examples of the subject include but not limited to human beings, fruits, vegetables, etc. The storage module 218 is configured with the external hardware unit 408 to store the relevant image.

The customization module 219 is configured with the external hardware unit 408 to customize the relevant image based on the identified features. The customized relevant image is transmitted to the algorithmic module via the cloud network. The received customized relevant image is transformed into a video sequence. The customized relevant image is transformed into a video sequence. The video sequence and the customized relevant image can be shared on a plurality of social media platforms.

Further, the captured multiple images can be compiled into an original video sequence which includes one or more music and word titles. In an embodiment, the users can share the video sequence, animation or still image with graphics. The present system is integrated with a plurality of social media platforms such as Facebook, Twitter.

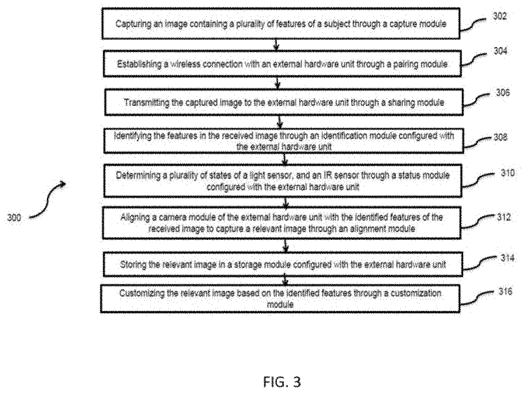

FIG. 3 illustrates a flowchart 300 of the method for capturing and customizing a relevant image of a subject and further allowing a user to share the relevant image over a network, in accordance with at least one embodiment. The method initiates with the step 302 of capturing an image containing a plurality of features of a subject through a capture module. The capture module is integrated with an algorithmic module via a cloud network. The cloud network establishes wireless communication between the algorithmic module and the capture module. The method comprises a step 304 of establishing a wireless connection with an external hardware unit through a pairing module integrated with the algorithmic module. The method then comprises a step 306 of transmitting the captured image to the external hardware unit through a sharing module integrated with the algorithmic module. Further, the method comprises a step 308 of identifying the features in the received image through an identification module configured with the external hardware unit. The method further comprises a step 310 of determining a plurality of states of a light sensor, and an IR sensor through a status module configured with the external hardware unit.

Furthermore, the method comprises a step 312 of aligning a camera module of the external hardware unit with the identified features of the received image to capture a relevant image through an alignment module configured with the external hardware unit, wherein the light sensor, and the IR sensor are integrated with the camera module. The method then comprises a step 314 of storing the relevant image in a storage module configured with the external hardware unit. Then the method comprises a step of customizing 316 the relevant image based on the identified features through a customization module configured with the external hardware unit. The present system can be utilized as a software application or web application.

FIG. 4 illustrates a first operational flowchart 400 of the present invention, in accordance with at least one embodiment. At step 402, the user captures the photo of subject's feature with a phone application. The phone application wirelessly pairs 404 with a hardware system. Then the phone application shares 406 the photo with the hardware system. At step 404, the hardware system identifies features in the initialization image. The software application positions 414 the camera hardware to align with an initialized feature image. Then the software application detects the eyes of the subject and identifies whether they are open or closed 416.

Further, the software application also detects the facial expression of the subject and identifies whether the subject is smiling or not 418. Accordingly, the image of the subject is captured 420 and stored in a local memory of the hardware system. Then a master image is duplicated, cropped, and aligned 422 on the facial features.

Further, the master image is wirelessly shared 424 with the phone application. The phone application converts 426 the images to a video sequence. Then the user shares 428 the video sequence or the images via the internet or phone network

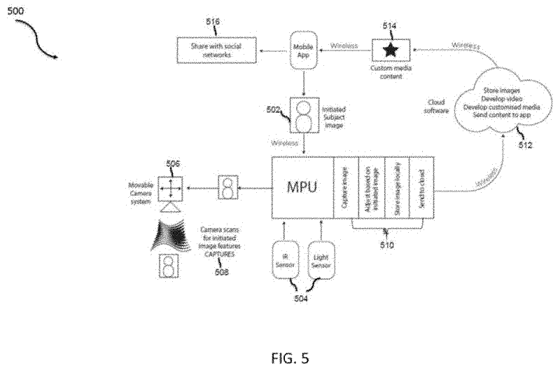

FIG. 5 illustrates a second operational flowchart 500 of the present invention, in accordance with at least one embodiment. A subject image is initiated 502 through a mobile application and wirelessly transmitted to the main processing unit (MPU). The MPU comprises an IR sensor and a light sensor. The IR sensor and the light sensor processes 504 the subject image and transmits 506 to a movable camera system. The movable camera system scans 508 the features of the subject image. Then the subject image is adjusted and aligned 510.

Further, the aligned image is stored in local storage (storage module) and transmitted 512 to the cloud storage. The cloud storage stores the images and develops a video sequence of the received images and allows the user to customize the images. Then the cloud storage transmits 514 the developed or customized data to a custom media content database. The custom media content database is wirelessly connected with the mobile application. The mobile application allows the user to share 516 the received customized and developed image data over several social media platforms.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A computer-implemented method comprises steps of:
capturing, by one or more processors, an image containing a plurality of features of a subject through a capture module, wherein the capture module is integrated with an algorithmic module via a cloud network, wherein the cloud network establishes a wireless communication between the algorithmic module and the capture module;
establishing, by one or more processors, a wireless connection with an external hardware unit through a pairing module integrated with the algorithmic module;
transmitting, by one or more processors, the captured image to the external hardware unit through a sharing module integrated with the algorithmic module;
identifying, by one or more processors, the features in the received image through an identification module configured with the external hardware unit;
determining, by one or more processors, a plurality of states of a light sensor, and an IR sensor through a status module configured with the external hardware unit;
aligning, by one or more processors, a camera module of the external hardware unit with the identified features of the received image to capture a relevant image through an alignment module configured with the external hardware unit, wherein the light sensor, and the IR sensor are integrated with the camera module;
storing, by one or more processors, the relevant image in a storage module configured with the external hardware unit; and
customizing, by one or more processors, the relevant image based on the identified features through a customization module configured with the external hardware unit.

2. The method according to claim 1, wherein the plurality of states comprises at least one of an ON state and an OFF state.

3. The method according to claim 1, wherein the alignment module further detects a plurality of facial expressions of the subject through a scanning camera configured with the external hardware unit.

4. The method according to claim 1, wherein the light sensor detects a plurality of light conditions.

5. The method according to claim 1, wherein the IR sensor detects at least one feature of the subject to determine a presence of the subject in the received image.

6. A device in a network, comprising:
a non-transitory storage device having embodied therein one or more routines operable to capture and customize a relevant image of a subject and further allows a user to share the relevant image over a network; and
one or more processors coupled to the non-transitory storage device and operable to execute the one or more routines, wherein the one or more routines include:
a capture module to capture an image containing a plurality of features of a subject, wherein the capture module is integrated with an algorithmic module;
a pairing module integrated with the algorithmic module to establish a wireless connection with an external hardware unit;
a sharing module integrated with the algorithmic module to transmit the captured image to the external hardware unit;
an identification module configured with the external hardware unit to identify the features in the received image;
a status module configured with the external hardware unit to determine a plurality of states of a light sensor and an IR sensor;
an alignment module configured with the external hardware unit to align a camera module of the external hardware unit with the identified features of the received image to capture a relevant image, wherein the light sensor, and the IR sensor are integrated with the camera module;
a storage module configured with the external hardware unit to store the relevant image; and
a customization module configured with the external hardware unit to customize the relevant image based on the identified features.

7. The device according to claim 6, wherein the plurality of states comprises at least one of an ON state and an OFF state.

8. The device according to claim 6, wherein the alignment module further detects a plurality of facial expressions of the subject through a scanning camera configured with the external hardware unit.

9. The device according to claim 6, wherein the light sensor detects a plurality of light conditions.

10. The device according to claim 6, wherein the IR sensor detects at least one feature of the subject to determine a presence of the subject in the received image.

11. A system to capture and customize a relevant image of a subject and further allows a user to share the relevant image over a network, the system comprises:
a processor; and
a memory to store machine-readable instructions that when executed by the processor cause the processor to:
capture an image containing a plurality of features of a subject through a capture module, wherein the capture module is integrated with an algorithmic module;
establish a wireless connection with an external hardware unit through a pairing module integrated with the algorithmic module;
transmit the captured image to the external hardware unit through a sharing module integrated with the algorithmic module;
identify the features in the received image through an identification module configured with the external hardware unit;
determine a plurality of states of a light sensor, and an IR sensor through a status module configured with the external hardware unit;
align a camera module of the external hardware unit with the identified features of the received image to capture a relevant image through an alignment module configured with the external hardware unit, wherein the light sensor, and the IR sensor are integrated with the camera module;
store the relevant image in a storage module configured with the external hardware unit; and
customize the relevant image based on the identified features through a customization module configured with the external hardware unit.

12. The system according to claim 11, wherein the plurality of states comprises at least one of an ON state and an OFF state.

13. The system according to claim 11, wherein the alignment module further detects a plurality of facial expressions of the subject through a scanning camera configured with the external hardware unit.

14. The system according to claim 11, wherein the light sensor detects a plurality of light conditions.

15. The system according to claim 11, wherein the IR sensor detects at least one feature of the subject to determine a presence of the subject in the received image.
